(19) United States
(12) Patent Application Publication
(10) Pub. No.: US 2007/0201231 A1
(43) Pub. Date: Aug. 30, 2007

(54) SYSTEM AND METHOD FOR RESETTING A LIGHT COUNTER

(75) Inventor: Donald Rhodes, Sherwood, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: InFocus Corporation, Wilsonville, OR (US)

(21) Appl. No.: 11/538,389

(22) Filed: Oct. 3, 2006

Related U.S. Application Data
(60) Provisional application No. 60/723,559, filed on Oct. 3, 2005.

(51) Int. Cl. F21V 23/04

(52) U.S. Cl. 362/276

(57) ABSTRACT

A system and method for resetting a light source counter is provided. One embodiment includes a light source assembly having an opening, a light source in the light source assembly, and an alterable material to temporarily obstruct light passage through the opening in the light source assembly when a new light source is powered on and allow light passage after light exposure. Another embodiment provides a method comprising detecting a signal from a photodetector, determining if the signal indicates a new light source, resetting a light source timer, and tracking usage time of the light source. Some embodiments may comprise a light source, a photodetector to detect light from the light source, and a controller coupled with the light source and the photodetector, the controller to reset a light source counter that keeps track of usage time of the light source in response to a signal from the photodetector.

### CROSS-REFERENCE TO RELATED APPLICATION

The present application claims priority to U.S. Provisional Patent Application Ser. No. 60/723,559 of Don Rhodes, entitled SYSTEM AND METHOD FOR RESETTING A LIGHT SOURCE COUNTER and filed Oct. 3, 2005, the disclosure of which is hereby incorporated by reference.

### TECHNICAL FIELD

The present disclosure relates generally to a display device, and more specifically to a system and method for resetting a light source counter in a display device.

### BACKGROUND

Many devices having a light source include a counter for monitoring a lifetime of the light source. This is because many light sources have emission characteristics that vary over the lifetime of the source. For example, a luminous intensity of a light source may decrease over the lifetime of the source. At some point, the intensity of the light source may drop to a level where the image is noticeably dimmed. Furthermore, such decreases in intensity may not be equal across the visible spectrum. Therefore, problems with color reproduction may also occur as the light source ages.

To prevent such problems, a display device may include a counter mechanism (or integrating or other tracking mechanism) for tracking a total amount of time that a light source is used. Likewise, the display device may include a mechanism, triggered by the counter reaching a predetermined value, for warning a user that a light source has exceeded a predetermined recommended lifetime, and/or a mechanism for preventing the normal use of the display device after the light source exceeds the predetermined recommended lifetime. Such mechanisms help to prompt a user to install a new light source, thereby ensuring that the quality of images produced by the display device remains high.

Upon the installation of a new light source, the light source counter is generally reset so that the lifetime of the new light source is measured correctly. In many prior systems, a user must manually reset the light source counter when a new light source is installed, for example, via a software control. If the user neglects to reset the counter, the display device may not function properly. Therefore, it may be desirable for the counter to reset automatically after the installation of a new light source.

### SUMMARY

A system and method for resetting a light source counter is provided. One embodiment includes a light source assembly having an opening, a light source in the light source assembly, and an alterable material to temporarily obstruct light passage through the opening in the light source assembly when a new light source is powered on and allow light passage after light exposure.

Another embodiment provides a method comprising detecting a signal from a photodetector, determining if the signal indicates a new light source, resetting a light source timer, and tracking usage time of the light source.

Some embodiments may comprise a light source, a photodetector to detect light from the light source, and a controller coupled with the light source and the photodetector, the controller to reset a light source counter that keeps track of usage time of the light source in response to a signal from the photodetector.

### BRIEF DESCRIPTION OF THE DRAWINGS

The disclosure is illustrated by way of example and not by way of limitation in the figures of the accompanying drawings, in which the like references indicate similar elements and in which:

FIG. 1 is a schematic depiction of an exemplary embodiment of a system for resetting a light source counter in a display device, showing an unused light source assembly.

FIG. 2 is a schematic depiction of the embodiment of FIG. 1, showing a used light source assembly.

FIG. 3 is a schematic depiction of the embodiment of FIG. 1, showing an alternate embodiment of a used light source assembly.

FIG. 4 is a flow diagram showing an exemplary embodiment of a method of resetting a light source counter.

### DETAILED DESCRIPTION

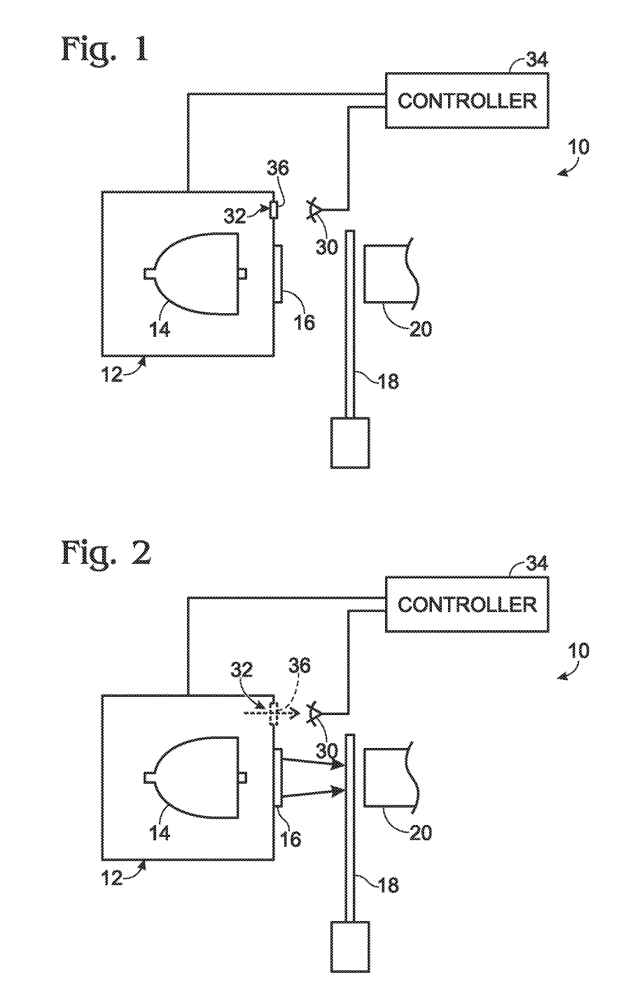

The present disclosure provides a system and method for resetting a light source counter in a display device or other device that includes a light source. FIG. 1 shows, generally at 10, a block diagram of an exemplary embodiment of a portion of a display system that includes a system for resetting a light source counter. Display system 10 includes a light source assembly 12 having a light source 14, one or more lenses 16, a color wheel or other light modulation device 18, and a tunnel or integrator 20. It will be appreciated that display system 10 may include various other components not shown herein, including but not limited to, lenses, beam splitters, one or more image-producing elements such as liquid crystal display (LCD) panels, digital micromirror devices (DMD), liquid crystal on silicon (LCOS) devices, etc. for image generation, projection lenses, and/or other passive and active optical components.

Display system 10 may be any suitable type of display device. Examples include, but are not limited to, front and rear projection display devices, portable display devices, permanently installed display devices, networked display devices, etc. Furthermore, the concepts disclosed herein may be extended to other devices than display devices that include a light source.

Display system 10 also includes a photodetector 30 configured to detect stray light that passes through an opening 32 in light source assembly 12. Photodetector 30 is in electrical communication with a controller 34, which can detect a signal output by the photodetector. Controller 34 is also in electrical communication with light source assembly 12, and may be configured to control a power on/power off state of light source 14. Furthermore, controller 34 may be in electrical communication with an image-producing element (not shown) to control the display of an end-of-lifetime message for light source assembly 12 when the light source assembly has exceeded a predetermined lifetime.

Light source assembly 12 also includes a material 36 that is alterable by the operation of light source 14. Alterable material 36 may be disposed in opening 32, may cover opening 32, or may otherwise be positioned such that light passing through opening 32 passes through alterable material 36 before reaching photodetector 30. The term “alterable material” as used herein includes materials with one or more physical properties that are modified by the operation of light source 14 in such a manner as to effect the transmission of light through opening 32 to photodetector 30.

In some embodiments, alterable material 36 is formed from an opaque (or partially opaque) material able to undergo a physical change that allows alterable material 36 to physically move from between light source 14 and photodetector 30 when light source 14 is first operated. This allows stray light to reach photodetector 30 after operation of light source 14 for a short period of time. For example, alterable material 36 may be made from a wax-based material, a thermoplastic polymer, a material that undergoes a solid/liquid phase transition, a solid/vapor phase transition, a glass/plastic phase transition, a viscosity decrease, or other such change when exposed to thermal and/or electromagnetic energy emitted by light source 14.

When a new light source assembly 12 is powered up for the first time, the passage of stray light through opening 32 is prohibited by alterable material 36. Therefore, substantially no light from opening 32 reaches photodetector 30. Controller 34 may be configured to detect the corresponding output from photodetector 30, and may reset a light source counter in response.

After running the new light source for some initial period of time, heat, light, or other energy emitted by light source 14 causes alterable material 36 to undergo some physical change that allows the material to melt, vaporize, sublime, or otherwise be transported away from opening 32. Once this occurs, light can pass through opening 32 to photodetector 30, as shown schematically in FIG. 2. In subsequent power-ups (or at any other suitable time), controller 34 may detect the output from photodetector caused by light from light source assembly 14 reaching photodetector. Controller 34 may be further configured to interpret this signal as representing a used light source assembly, and may be configured not to reset the light source counter in response to detecting this signal.

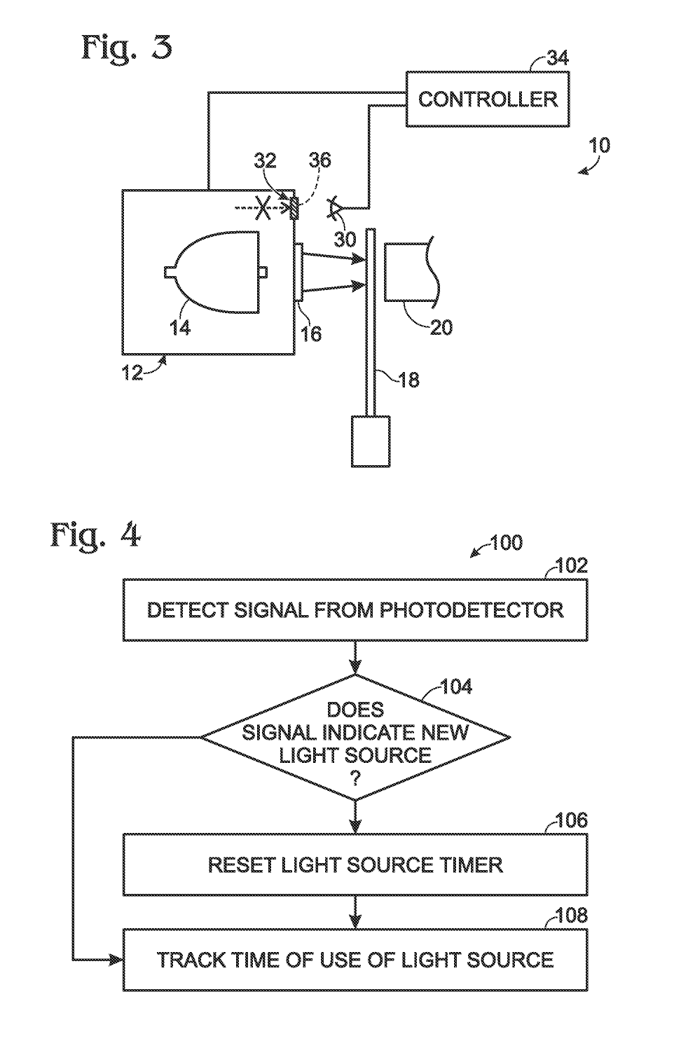

In other embodiments, alterable material 36 may be formed from, or may include, a material with optical properties configured to change upon the first operation of light source 14. For example, alterable material 36 may include a material, or a mixture of materials, that either turns from translucent to opaque when exposed to thermal and/or electromagnetic energy from light source 14, as illustrated by FIG. 3, or that turns from opaque to translucent under such conditions.

In these embodiments, controller 34 may be configured to examine the signal from photodetector 30 at power up (or other suitable time). If light source assembly 12 is new, alterable material 36 will have a translucency that indicates a “new” light source state to controller 34 for a brief period before the translucency changes due to energy output by light source 14. Therefore, controller 34 may detect that the light source is new during this initial window of time, and in response may reset the lamp counter. During subsequent power up events (or at any other suitable time), the transparency change that occurred in response to the initial power up indicates to controller 34 that the light source is used. In response to detecting the “used” signal from photodetector 30, controller does not reset the lamp counter.

FIG. 4 shows, generally at 100, a flow diagram of an exemplary embodiment of a method for resetting a light source counter. Method 100 first includes, at 102, detecting a signal from a photodetector. Next, method 100 includes, at 104, determining whether the signal from the photodetector indicates that the light source is new. If the signal from the photodetector does indicate that the light source is new, method 100 next includes, at 106, resetting a light source counter to an appropriate setting for a new light source, and then at 108, incrementing the counter with continued use of the lamp. On the other hand, if the signal from the photodetector does not indicate that the light source is new, then the counter is not reset, and the counter continues to increment without being reset.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein.

Inventions embodied in various combinations and subcombinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

What is claimed is:

1. A display device comprising:
a light source assembly having an opening;
a light source in the light source assembly; and
an alterable material to temporarily obstruct light passage through the opening in the light source assembly when a new light source is powered on and then allow light passage after a predetermined period of light exposure.

2. The display device of claim 1, further comprising a photodetector to detect light from the light source through the opening, and a controller operably coupled to the light source and the photodetector, the controller to reset a light source counter responsive to the photodetector detecting light from the light source through the opening.

3. The display device of claim 1, wherein the alterable material melts, vaporizes, sublimes, changes viscosity, or changes the amount of light that passes through the alterable material.

4. The display device of claim 1, wherein the alterable material is at least one of a wax based material, a thermoplastic polymer, a material that undergoes a solid/liquid phase transition, a material that undergoes a solid/vapor phase transition, a material that undergoes a glass/plastic phase transition, and a material that undergoes a viscosity decrease.

5. The display device of claim 1, wherein the alterable material is physically changed by at least one of light and heat from the light source.

6. The display device of claim 1, wherein the display device is at least one of a front projection display device, a rear projection display device, a portable display device, a permanently installed display device, and a networked display device.

7. A display system comprising:
a light source;
a photodetector to detect light from the light source; and
a controller coupled with the light source and the photodetector, the controller to reset a light source counter that keeps track of usage time of the light source in response to a signal from the photodetector.

8. The display system of claim 7, further comprising an alterable material between the light source and the photodetector, the alterable material to allow light to reach the photodetector from the light source after undergoing a physical change.

9. The display system of claim 8, wherein the alterable material melts, vaporizes, sublimes, changes viscosity, or changes the amount of light that passes through the alterable material.

10. The display system of claim 8, wherein the alterable material is at least one of a wax based material, a thermoplastic polymer, a material that undergoes a solid/liquid phase transition, a material that undergoes a solid/vapor phase transition, a material that undergoes a glass/plastic phase transition, and a material that undergoes a viscosity decrease.

11. The display system of claim 8, wherein the alterable material temporarily prevents light passage when a new light source assembly is powered on.

12. The display system of claim 8, wherein the alterable material is physically changed by at least one of light and heat from the light source.

13. The display system of claim 7, further comprising the controller to not reset a light source timer if the signal from the photodetector indicates a used light source.

14. A method comprising:
detecting a signal from a photodetector indicating a new light source;
resetting a light source timer; and
tracking usage time of the light source.

15. The method of claim 14, further comprising physically changing an alterable material between the light source and the photodetector to allow light to reach the photodetector from the light source.

16. The method of claim 15, wherein physically changing an alterable material comprises at least one of melting, vaporizing, subliming, changing viscosity, or changing the amount of light passing through the alterable material.

17. The method of claim 14, wherein the alterable material is at least one of a wax based material, a thermoplastic polymer, a material that undergoes a solid/liquid phase transition, a material that undergoes a solid/vapor phase transition, a material that undergoes a glass/plastic phase transition, and a material that undergoes a viscosity decrease.

18. The method of claim 15, wherein the alterable material initially prevents light passage when a new light source assembly is powered on.

19. The method of claim 15, wherein the alterable material is physically changed by at least one of light and heat from the light source.

20. The method of claim 14, further comprising not resetting a light source timer if the signal from the photodetector indicates a used light source.
